(19) United States
(12) Patent Application Publication
(10) Pub. No.: US 2016/0086529 A1
(43) Pub. Date: Mar. 24, 2016

(54) DISPLAY APPARATUS INCORPORATING AMBIENT LIGHT DEPENDENT SUBFRAME DIVISION

(71) Applicant: PIXTRONIX, INC., San Diego, CA (US)

(72) Inventors: Robert Louis Myers, Andover, MA (US); Edward Buckley, Melrose, MA (US); Alan Gerald Lewis, Sunnyvale, CA (US); Jignesh Gandhi, Burlington, MA (US); Fahri Yaras, Reading, MA (US)

(73) Assignee: PIXTRONIX, INC., San Diego, CA (US)

(21) Appl. No.: 14/490,784

(22) Filed: Sep. 19, 2014

(51) Int. Cl. G09G 3/20; G09G 3/36; G09G 3/34

(52) U.S. Cl. CPC G09G 3/2022; G09G 3/2003; G09G 3/3413; G09G 3/3696; G09G 3/3688; G09G 2320/0247; G09G 2320/064; G09G 2320/0666; G09G 2320/0673

(57) ABSTRACT

This disclosure provides systems, methods and apparatus for reducing flicker in display devices. In some image formation processes, a controller can form an image by utilizing a set of color subfields in displaying subframes associated with each of the color subfields. In some implementations, the controller may determine whether to divide or split the display of certain subframes based on environmental factors such as ambient light with or without concern for flicker. In some implementations, the controller may determine to divide or split the display of an x-channel subframe based on the ambient light. The controller can monitor the ambient light levels via an ambient light sensor, and compare the ambient light level to an ambient light threshold. If the ambient light levels go below the ambient light threshold, the controller can employ subframe division or splitting.

### TECHNICAL FIELD

This disclosure relates to the field of displays, and in particular, to image formation processes used by displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus, including input logic configured to receive image data associated with an image frame, subfield generation logic configured to derive a composite color subfield based on the received image frame, where the derived composite color subfield identifies a composite color intensity value with respect to each of a plurality of display elements in a display for the received image frame, subframe generation logic configured to generate a plurality of at least partially temporally weighted subframes for the derived composite color subfield, where each generated subframe has a default illumination duration, has a default illumination intensity, and indicates states of the respective display elements in the display, an ambient light sensor configured to measure an ambient light level, and control logic configured to, based on a determination that the ambient light level fails to exceed an ambient light threshold, display a first of the generated subframes associated with the composite color subfield during at least two separate illumination periods.

In some implementations, a combined duration of the at least two illumination periods is substantially equal to the default illumination duration associated with the first of the generated subframes. In some implementations, the control logic is further configured to increase illumination intensities of one or more light sources being illuminated during display of the first of the generated subframes during the at least two separate illumination periods to be greater than the default illumination intensity. In some implementations, the control logic is further configured to increase the illumination intensities for the first of the generated subframes as a function of a decrease in the illumination duration for the first of the generated subframe from its default illumination duration.

In some implementations, the subfield generation logic is further configured to generate color subfields for a plurality of component colors. In some implementations, the control logic is configured to, upon determining that the ambient light levels exceed the ambient light threshold, display each of the generated subframes associated with the composite color as individual, temporally contiguous subframes. In some implementations, the determination that the ambient level fails to exceed the ambient light threshold includes a determination that an ambient light-to-display brightness ratio fails to exceed an ambient light-to-display brightness ratio threshold. In some implementations, the plurality of display elements include MEMS shutter-based light modulators.

In some implementations, the apparatus further includes a display, a processor that is capable of communicating with the display, the processor being capable of processing image data, and a memory device that is capable of communicating with the processor. In some implementations, the display further includes a driver circuit capable of sending at least one signal to the display, and a controller capable of sending at least a portion of the image data to the driver circuit. In some implementations, the display further includes an image source module capable of sending the image data to the processor, where the image source module includes at least one of a receiver, transceiver, and transmitter.

Another innovative aspect of the subject matter described in this disclosure can be implemented in a method of forming an image on a display including receiving image data associated with an image frame, deriving a composite color subfield for the received image frame, where the derived composite color subfield identifies a composite color intensity value with respect to each of a plurality of display elements in a display for the received image frame, generating a plurality of at least partially temporally weighted subframes for the derived composite color subfield, where each generated subframe has a default illumination duration, has a default illumination intensity, and indicates states of the respective display elements in the display, measuring an ambient light level, and displaying, based on a determination that the ambient light level fails to exceed an ambient light threshold, a first of the generated subframes associated with the composite color subfield during at least two separate illumination periods.

In some implementations, displaying a first of the generated subframes during at least two separate illumination periods includes displaying the first of the generated subframe such that a combined duration of the at least two illumination periods is substantially equal to the default illumination duration associated with the first of the generated subframes. In some implementations, the method further includes increasing illumination intensities of one or more light sources being illuminated during display of the first of the generated subframes during the at least two separate illumination periods to be greater than the default illumination intensity. In some implementations, increasing illumination intensities of one or more light sources being illuminated during display of the first of the generated subframes as a function of a decrease in the illumination duration of the first of the generated subframes from its default illumination duration.

In some implementations, the method further includes generating color subfields for a plurality of component colors. In some implementations, the method further includes, upon determining that the ambient light levels exceed the ambient light threshold, displaying each of the generated subframes associated with the composite color subfield as individual, temporally contiguous subframes. In some implementations, the determination that the ambient level fails to exceed the ambient light threshold includes a determination that an ambient light-to-display brightness ratio fails to exceed an ambient light-to-display brightness ratio threshold.

Another innovative aspect of the subject matter described in this disclosure can be implemented in a non-transitory computer readable storage medium having instructions encoded thereon, which when executed by a processor cause the processor to perform a method for displaying an image, including receiving image data associated with an image frame, deriving a composite color subfield for the received image frame, where the derived composite color subfield identifies a composite color intensity value with respect to each of a plurality of display elements in a display for the received image frame, generating a plurality of at least partially temporally weighted subframes for the derived composite color subfield, where each generated subframe has a default illumination duration, has a default illumination intensity, and indicates states of the respective display elements in the display, measuring an ambient light level, and displaying, based on a determination that the ambient light level fails to exceed an ambient light threshold, a first of the generated subframes associated with the composite color subfield during at least two separate illumination periods.

In some implementations, displaying a first of the generated subframes during at least two separate illumination periods includes displaying the first of the generated subframe such that a combined duration of the at least two illumination periods is substantially equal to the default illumination duration associated with the first of the generated subframes.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of example control logic suitable for use in the display apparatus shown in FIG. 3.

FIGS. 5A-5B show flow diagrams of an example process for generating an image on a display.

FIG. 6A shows an example timing diagram for utilizing subframe dividing as a flicker mitigating measure.

FIG. 6B shows an example timing diagram utilizing subframe time period reduction as a flicker mitigating measure.

FIG. 7 shows a flow diagram of another example process for displaying an image frame.

FIG. 8 shows a flow diagram of an example process for dividing subframes based on ambient light conditions.

FIGS. 9A and 9B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some image formation processes, a controller can form an image by utilizing a set of color subfields and displaying subframes associated with each of the color subfields. In some implementations, the controller can utilize a set of color subfields including colors such as red, green, blue, and composite colors that are formed from the combination of two or more other subfields. For example some composite color subfields (also referred to as “x-channel”) can be a composite of colors red, green, and blue. In some implementations, the controller may determine whether to divide or split the display of certain subframes based on environmental factors such as ambient light with or without concern for flicker. In some implementations, dividing or splitting the display of a subframe can include displaying the same subframe over two or more illumination periods. In some implementations, the controller may determine to divide or split the display of an x-channel subframe based on the ambient light. The controller can monitor the ambient light levels via an ambient light sensor, and compare the ambient light level to an ambient light threshold. If the ambient light levels go below the ambient light threshold, the controller can employ subframe division or splitting.

Particular implementations of the subject matter described in this disclosure can be implemented to realize one or more of the following potential advantages. In general, image formation processes disclosed herein mitigate image artifacts, and improve image quality, by dividing an illumination period of a subframe into two or more illumination periods. In some implementations, dividing the illumination period of a subframe can result in an increase in power consumption. By basing the decision on whether to divide illumination periods of subframes on environmental conditions such as ambient light levels, the image formation process can balance improved image quality with increased power consumption.

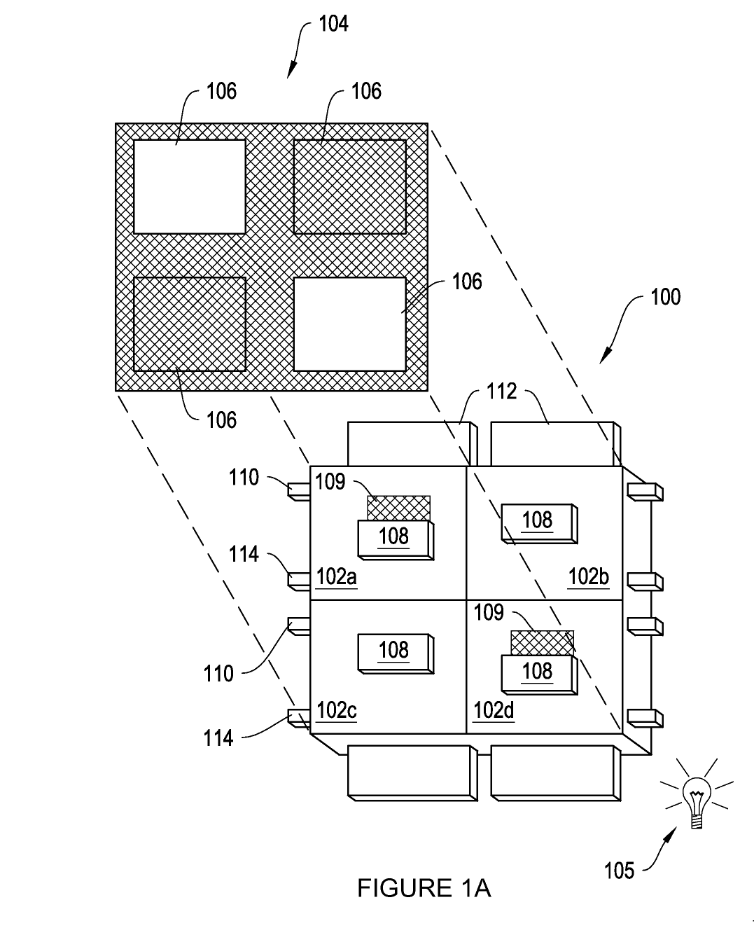

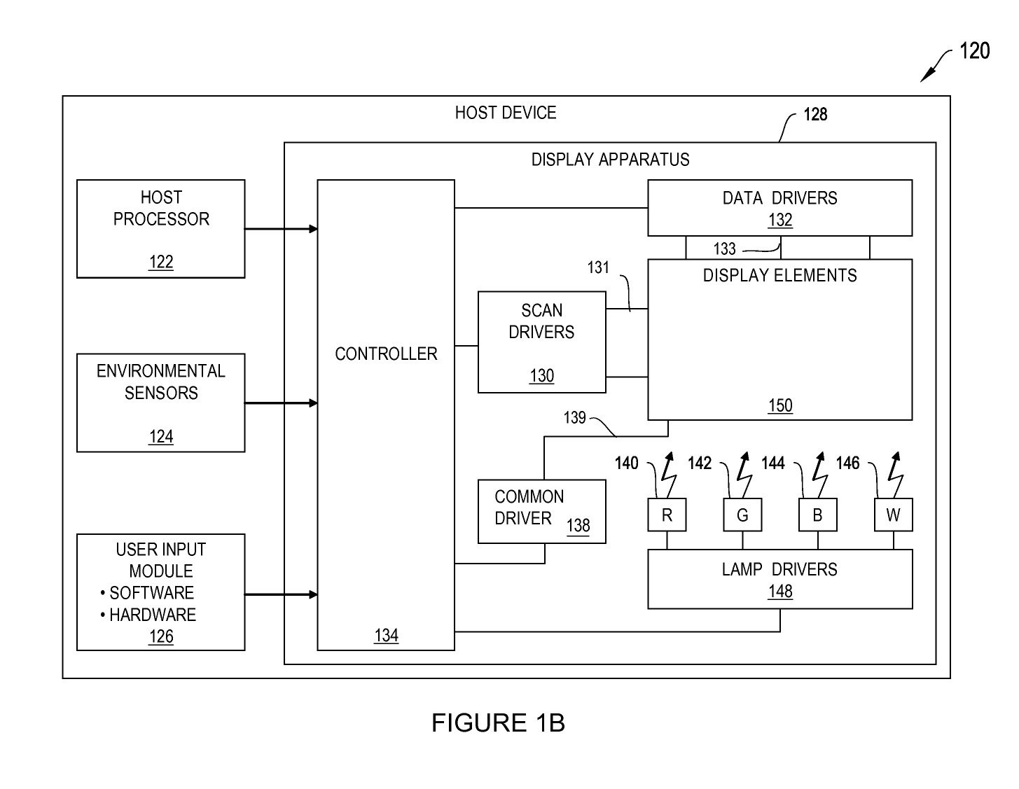

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

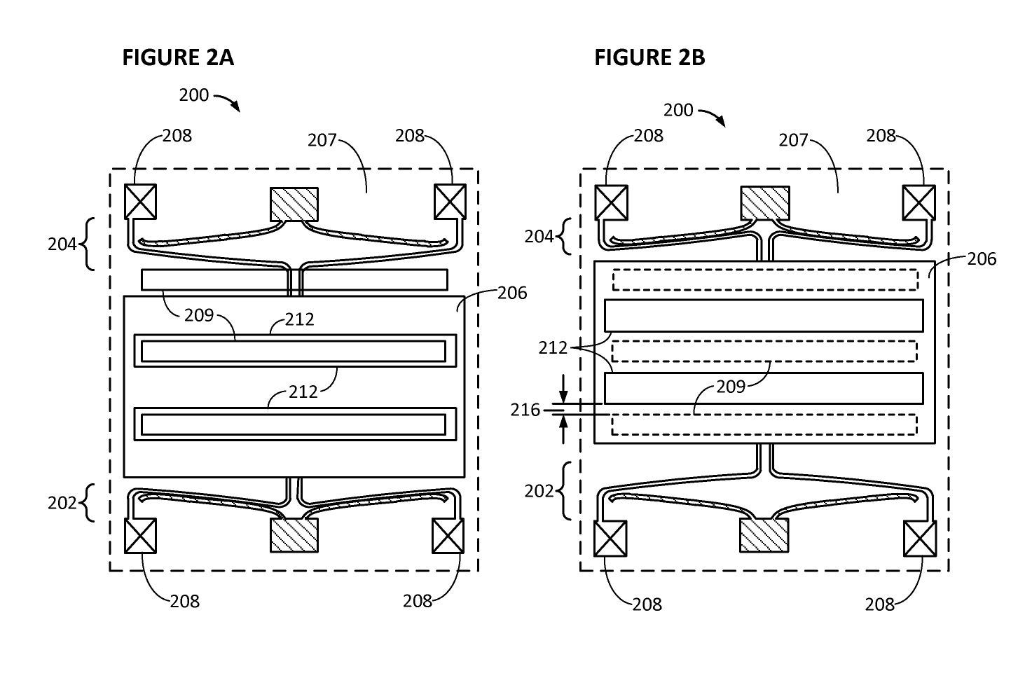

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

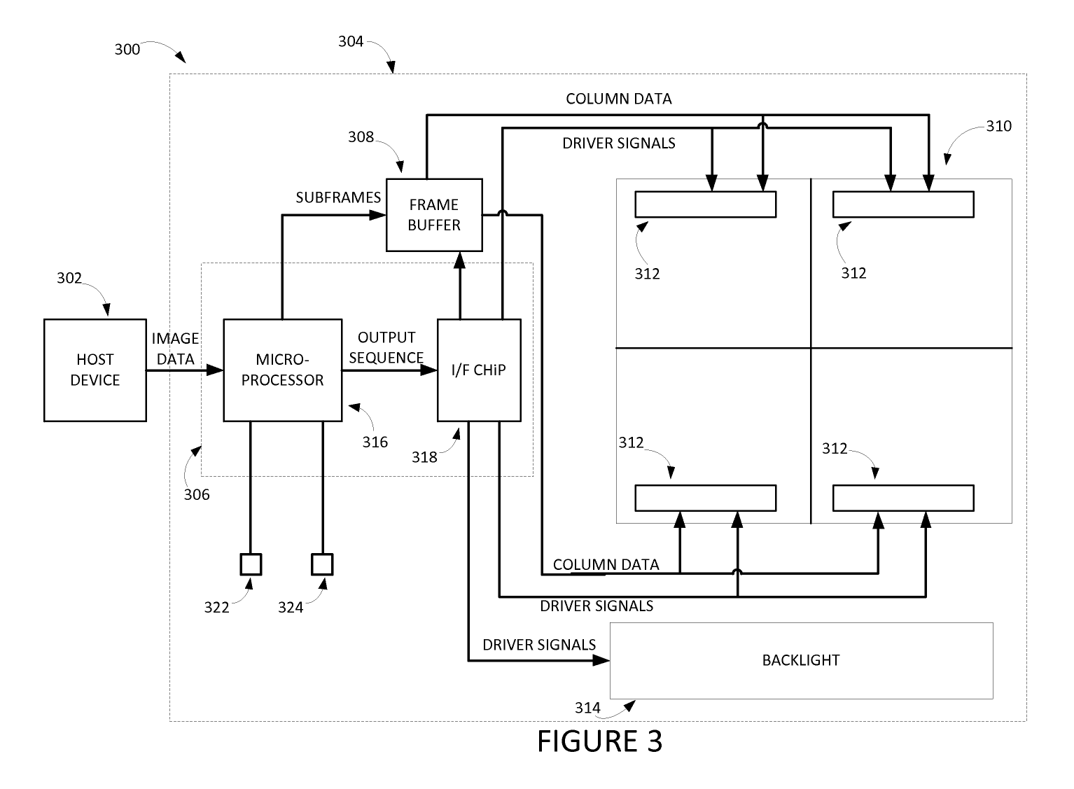

FIG. 3 shows a block diagram of an example display apparatus 300. The display apparatus 300 includes a host device 302 and a display module 304. The host device can be any of a number of electronic devices, such as a portable telephone, a smartphone, a watch, a tablet computer, a laptop computer, a desktop computer, a television, a set top box, a DVD or other media player, or any other device that provides graphical output to a display. In general, the host device 302 serves as a source for image data to be displayed on the display module 304.

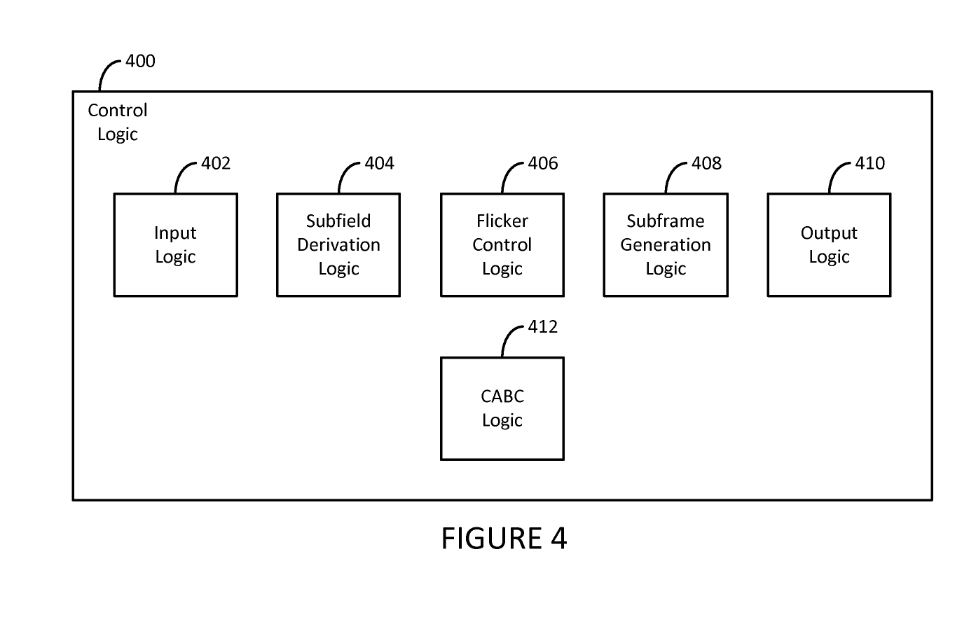

The display module 304 further includes control logic 306, a frame buffer 308, an array of display elements 310, display drivers 312 and a backlight 314. In general, the control logic 306 serves to process image data received from the host device 302 and controls the display drivers 312, array of display elements 310 and backlight 314 to together produce the images encoded in the image data. The functionality of the control logic 306 is described further below in relation to FIGS. 4-6.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, and parameters associated with implementing the appropriate weight for each of the image subframes. These parameters may include, in various implementations, the duration for which each of the respective image subframes is to be illuminated and the intensity of such illumination. These parameters (i.e., the number of subframes, the order and timing of their output, and their weight implementation parameters for each subframe) can be collectively referred to as an “output sequence.”

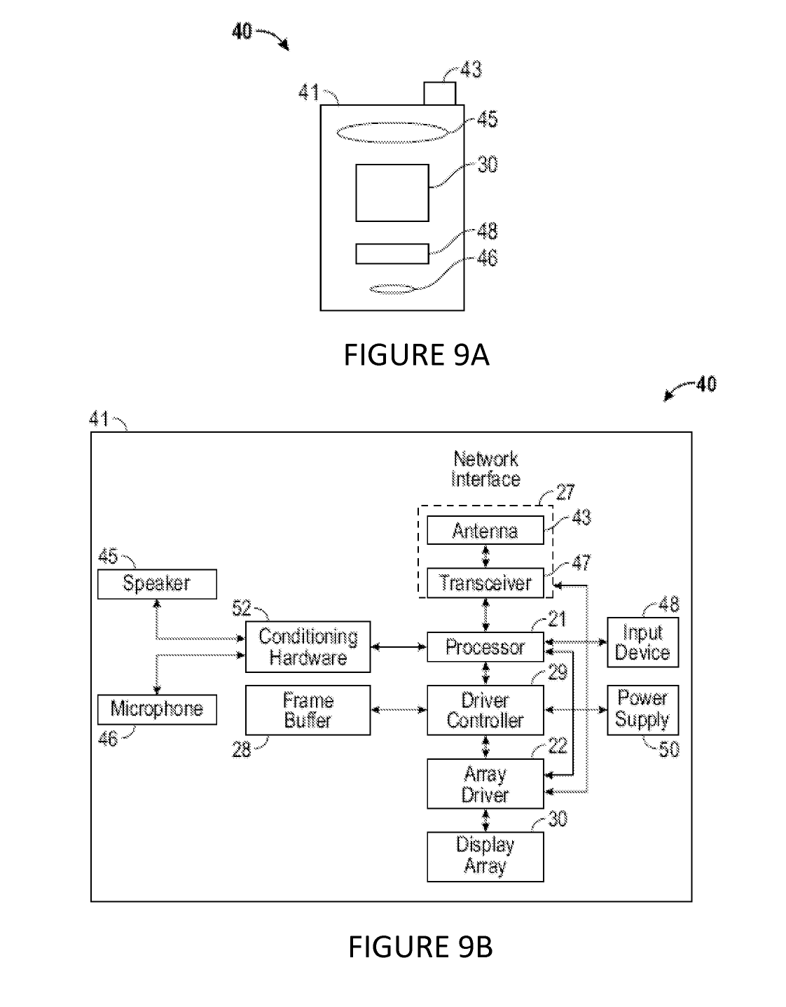

The interface chip 318 can be configured to carry out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. The frame buffer 308 can be any volatile or non-volatile integrated circuit memory, such as DRAM, high-speed cache memory, or flash memory (for example, the frame buffer 308 can be similar to the frame buffer 28 shown in FIG. 9B). In some other implementations, the interface chip 318 causes the frame buffer 308 to output data signals directly to the display drivers 312.

In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 9B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion reduces the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 314 can include a light guide, one or more light sources (such as LEDs), and light source drivers. The light sources can include light sources of multiple primary colors, such as red, green, blue, and in some implementations white. The light source drivers are configured to individually drive the light sources to a plurality of discrete light levels to enable illumination gray scale and/or content adaptive backlight control (CABC) in the backlight. For example, CABC can include dynamically normalizing the intensity values of one or more subfields such that the maximum intensity value in each normalized subfield is scaled to the maximum intensity value output by the display scaling down the illumination levels of the corresponding LEDs accordingly. The light guide distributes the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination grayscale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

In some implementations, the display module 304 can include or be coupled to an ambient light sensor 322 and/or a proximity sensor 324. The ambient light sensor 322 can sense a level of background illumination. In some implementations, the ambient light sensor 322 can output a voltage/current, or a digital output corresponding to the ambient light level. Likewise, the proximity sensor 324 can output a voltage/current or a digital output corresponding to the proximity of a viewer to the display module 304. As discussed below, the microprocessor 316 can utilize the ambient light sensor 322 and/or the proximity sensor 324 in determining the ambient light levels and the proximity of the viewer from the display module 304. This information can be used by the microprocessor 316 to control various aspects of the display module 304 to reduce flicker.

FIG. 4 shows a block diagram of example control logic 400 suitable for use as, for example, the control logic 306 in the display apparatus 300 shown in FIG. 3. More particularly, FIG. 4 shows a block diagram of functional modules executed by the microprocessor 316. Each functional module can be implemented as software in the form of computer executable instructions stored on a tangible computer readable medium, which can be executed by the microprocessor 316 or by an ASIC. The control logic 400 includes input logic 402, subfield derivation logic 404, flicker control logic 406, subframe generation logic 408 and output logic 410. In some implementations, the control logic 400 may also include CABC logic 412. While shown as separate functional modules in FIG. 4, in some implementations, the functionality of two or more of the modules may be combined into one or more larger, more comprehensive modules.

The input logic 402 is configured to receive the input image data as a stream of pixel intensity values, and present the pixel intensity values to other modules within the control logic 400. The subfield derivation logic 404 can derive color subfields (e.g., red, green, blue, white, etc.) based on the pixel intensity values. The flicker control logic 406 can detect the potential for flicker and coordinate with the output logic 410 and the subframe generation logic 408 to mitigate that potential. The subframe generation logic 408 can generate subframes for each of the color subfields based on an output sequence and the pixel intensity values. The CABC logic 412 can implement CABC techniques for reducing power consumption. The output logic 410 can coordinate with one or more of the other logic components to determine an appropriate output sequence, and then use the output sequence to display the subframes on the display.

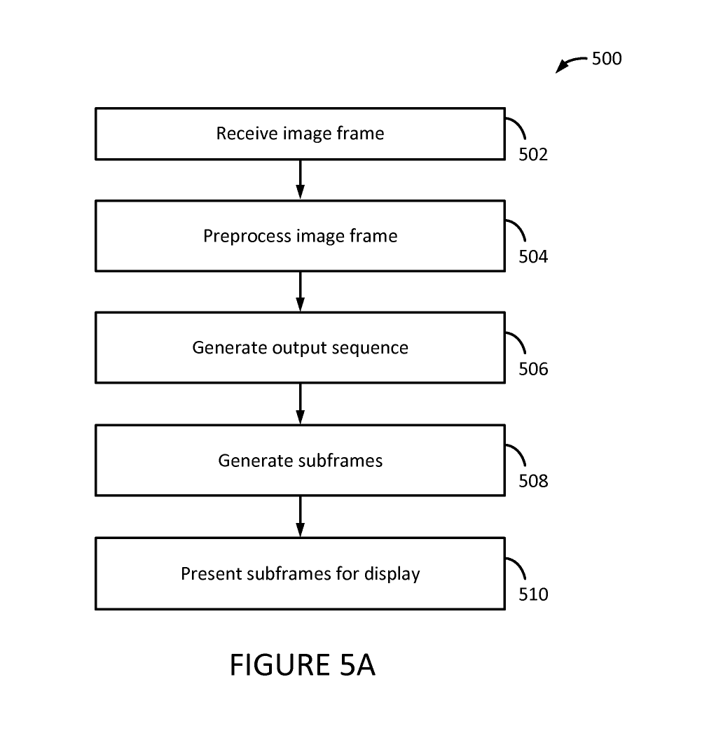

In some implementations, when executed by the microprocessor 316, the components of the control logic 400, along with the interface chip 318, display drivers 312, and backlight 314 (all shown in FIG. 3), function to carry out a method for generating an image on a display, such as the method 500 shown in FIGS. 5A and 5B. The functionality of the components of the control logic 400 is described further in relation to various operations carried out as part of the method 500.

FIG. 5A shows a flow diagram of an example method 500 for generating an image on a display. The method 500 includes receiving an image frame (stage 502), preprocessing the image frame (stage 504), generating an output sequence (stage 506), and, generating subframes for display (stage 508), and presenting subframes for display (stage 510).

Referring to FIGS. 1B, and 3-5A, the method 500 begins with the input logic 402 receiving image data in the form of image frames (stage 502). Typically, such image data is obtained by the input logic 402 as a stream of intensity values for the red, green, and blue components of each pixel in an image frame. The intensity values typically are received as binary numbers. The image data may be received directly from an image source, such as from an electronic storage medium incorporated into the display apparatus 128. Alternatively, it may be received from a host processor 122 incorporated into the host device 120 in which the display apparatus 128 is built.

In some implementations, the method further includes preprocessing the received image frame (stage 504). For example, in some implementations, the image data includes color intensity values for more pixels or fewer pixels than are included in the display apparatus 128. In such cases, the input logic 402, the subfield derivation logic 404, or other logic incorporated into the controller 400 can scale the image data appropriately to the number of pixels included in the display apparatus 128. In some other implementations, the image frame data is received having been encoded assuming a given display gamma. In some implementations, if such gamma encoding is detected, logic within the controller 400 applies a gamma correction process to adjust the pixel intensity values to be more appropriate for the gamma of the display apparatus 128. For example, image data is often encoded based on the gamma of a typical liquid crystal (LCD) display. To address this common gamma encoding, the controller 400 may store a gamma correction lookup table (LUT) from which it can quickly retrieve appropriate intensity values given a set of LCD gamma encoded pixel values. In some implementations, the LUT includes corresponding RGB intensity values having a 16 bit-per-color resolution, though other color resolutions may be used in other implementations.

In some implementations, image frame preprocessing (stage 504) includes a dithering stage. In some implementations, the process of de-gamma encoding an image results in 16 bit-per-color pixel values, even though the display apparatus 128 may not be configured for displaying such a large number of bits per color. A dithering process can help distribute any quantization error associated with converting these pixel values down to a color resolution available to the display, such as 4, 5, 6, or 8 bits per color.

In some implementations, the image preprocessing (stage 504) can include the subfield derivation logic 404 selecting a set of color subfields for displaying the image frame. In some implementations, the selected color subfields can include, frame independent contributing colors (FICCs) such as, without limitations, the colors red (R), green (G), blue (B), white (W), yellow (Y), magenta (M), cyan (C), or one or more combinations thereof. FICCs are selected independently of the image content or data associated with the image frame. In some implementations, the FICCs can include composite colors that are formed from the combination of two or more other FICCs. In some implementations, the selection of color subfields can include selecting a frame specific contributing color (FSCC). FSCCs are typically determined based on the image data associated with the current and/or one or more previous image frames. In some implementations, the subfield derivation logic 404 can be utilized to determine intensity values for each of the pixels in an FSCC color subfield and to adjust the intensities of the FICCs for each pixel of the display based on the determined FSCC intensity values.

As mentioned above, the FSCCs can be selected based on the image data associated with an image frame. In some implementations, the FSCC can be selected based on converting received image data into XYZ tristimulus values, identifying a color corresponding to the median (or mean) of the tristimulus values, and setting the FSCC to, or based on, the identified color. In some implementations, the identified color is compared to a set of available FSCCs, and the FSCC is set to the available FSCC that is closest to the identified color. In some implementations, the FSCC can be selected between white and any color that is near to the boundaries of the available color gamut utilized for the display. In some other implementations, the FSCC can be selected based on the dominant hue within the image frame. In some implementations, the FSCC can be selected from one of, or a combination of, the following colors: white, yellow, cyan, magenta, etc.

In some implementations, the image preprocessing (stage 504) can include updating the subfields using CABC. The CABC logic 412, after the FSCC subfields and FICC subfields are derived, can normalize the intensity values in one or more of the subfields such that the maximum intensity value in each normalized subfield is scaled to the maximum intensity value output by the display. For example, in a display capable of outputting 256 gray scale levels, the subfield values are scaled such that the maximum intensity value therein is equal to 255. The illumination levels of the corresponding LEDs can be accordingly scaled down. The scaling factor for the LEDs can be used by the output logic 410 for adjusting the LED illumination levels.

The process 500 further includes generating an output sequence to use in displaying the received image (stage 506). An output sequence for a given image frame includes a series of events for displaying a series of subframes associated with the image frame. In some implementations, the output sequence can include a series of data and control signals to drivers, such as the data drivers 132, scan drivers 130 and lamp drivers 148 shown in FIG. 1B. For example, the output sequence can include a sequence of events for outputting subframes, where each subframe represents a set of data identifying desired display element states for display elements in multiple rows and multiple columns of the display. The output sequence can also include the intensities and durations of the appropriate light sources to be illuminated during each subframe.

The generation of the output sequence can include several processing stages, which are described in detail below in relation to FIG. 5B. In particular, the processing can include determining a critical flicker frequency (CFF) associated with each subframe of each subfield and employing flicker mitigating measures to one or more of the subframes if the CFF associated with any of those subframes exceeds an illumination frequency value. In some implementations, the subframes generated by the control logic 400 can be a function of the flicker mitigating measures. In some implementations, the flicker mitigating measures may result in adjusting display parameters determined during the preprocessing of the image frames. For example, some flicker mitigating measures may result in a change in the number of times a subframe is shown or the duration of subframes that would otherwise be used based on the preprocessing of the image frame (stage 502). In some implementations, the control logic 400 can generate an output sequence based on the changed display parameters.

The process 500 further includes generating subframes (stage 508). The subframe generation logic 408 can generate a set of subframes based on the output sequence and the intensity values for each subfield color for each pixel. The generated subframes can be loaded into an array of display elements, such as the array 150 of display elements shown in FIG. 1B, to reproduce the image encoded in the received image data. In some implementations, the subframe generation logic 408 can generate digital data or codewords that indicate the state of the display elements within the display elements. In some implementations, where the display elements include light modulators that can be placed in only two states (such as an OPEN and a CLOSED state), the subframe generation logic 408 can generate bitplanes. Each bitplane includes, for each display element, the value in one position of a binary codeword associated with the subfield intensity value. In some implementations, the subframe generation logic 408 can include a look-up-table (LUT) that associates each subfield intensity value with a codeword. The subframes for each subfield can be stored in the frame buffer 308 (shown in FIG. 3) from where they can be loaded into the array of display elements.

The process 500 further includes presenting the subframes for display (stage 510). Once the output sequence is generated by the control logic 400 (stage 506) and the subframes for the image frame have been generated (stage 408), the output logic 410 uses the output sequence to display the subframes on the display. The output logic 410 can be configured to control output signals to a remainder of the components of the display apparatus to cause the subframes to be presented to a viewer. For example, if used in the display apparatus 128 shown in FIG. 1B, the output control logic 410 would control the output of signals to the data drivers 132, scan drivers 130 and lamp drivers 148 shown in FIG. 1B to load the subframes into the display elements in the array 150, and then to illuminate the display elements with the lamps 140, 142, 144 and 146. In some implementations, the output logic 410 can scale the illumination levels for the LEDs based on a scaling factor determined by the CABC logic 412.

FIG. 5B shows a flow diagram of an example process 550 for generating an output sequence. The process 550 can be used, for example, in stage 506 shown in FIG. 5A for generating an output sequence. The process 550 includes determining initial numbers, weights, and timings of subframes to be displayed (stage 510), calculating the CFFs associated with each subframe (stage 512), determining whether the CFFs associated with any subframe exceed an illumination frequency of the respective subframe (stage 514), executing one or more flicker mitigating measures (stage 516), determining light source intensities (stage 518), and providing the output sequence (stage 520).

The process 550 includes determining initial numbers, weights, and timings of subframes to be displayed (stage 511). In some implementations, the subframe generation logic 408 can determine the initial numbers, weights and durations of subframes to be used for displaying each FICC and the FSCC subfield. In some implementations, the initial numbers, weights, and the durations of the subframes used for displaying the FICC and the FSCC subfields can be based on the display techniques used. For example, in some grayscale field sequential color technique, the subframes can be binary weighted. According to a binary weighted scheme, each successive subframe for a given FICC or FSCC is assigned a weight that is twice that of the subframe having the next lower weight, for example, 1, 2, 4, 8, 16, 32, etc.

In some implementations, the weights can be assigned to successively weighted subframes based on a non-binary weighing scheme. In some such implementations, the output sequence can include multiple subframes of the same color having the same weight and/or include subframes whose weights are more or less than twice the weight of the subframe having the next lower weight. For example, in some implementations, successive subframes for a given color may have weights such as 80, 32, 16, 8, 4, 1, 2, 32, and 80. Generally, the duration of each subframe can be determined based on the relative weight associated with the subframe. For example, when the subframes are binary weighted as discussed above, assuming a constant illumination level for each subframe, the duration of each successively weighted subframe would be twice the duration of the next lower weighted subframe.

The process 550 includes calculating a critical flicker frequency (CFF) associated with each subframe of each color (stage 512). The CFF for a subframe of a color is the minimum frequency at which the subframe of that color must be illuminated to avoid the perception of flicker by a viewer. The actual frequency at with which a subframe is displayed is referred to herein as the “illumination frequency” of the subframe. In some implementations, the illumination frequency of a subframe is about the same as the frame rate of the display (i.e., the rate at which image frames are displayed by the display apparatus 300). Thus, if the display apparatus 300 displays image frames at a frame rate of 60 Hz, then the illumination frequency of each subframe may also be about 60 Hz. In some such implementations, flicker can be avoided for a subframe if the illumination frequency of the subframe is greater than the CFF.

The flicker control logic 406 (shown in FIG. 4) calculates the CFF for the subframes using a CFF model. The CFF model takes into consideration values of various parameters related to, for example, the display apparatus 300, the viewer, image display characteristics, etc., to determine the CFF for each of the subframes.

The CFF model takes into account the width w and height h of the display module 304 from a given diagonal measurement dg and an aspect ratio ar of the display module 304. For example,

$$\begin{matrix}h = \frac{dg}{\sqrt{1 + {ar}^{2}}} , \\ and & ( 1 ) \\ w = \frac{dg}{\sqrt{1 + {ar}^{- 2}}} & ( 2 )\end{matrix}$$

The CFF model also takes into account a display visual angle θ subtended by the display module 300 on the viewer's eye. For example, the display visual angle θ can be determined by:

$$θ = 2 {tan}^{- 1} ( \frac{D}{2 V} ) \qquad ( 3 )$$

where D represents a display diameter of the display module 304 and can be approximated by the greater of the width w and the height h of the display module 304; and V represents the viewing distance between the display module and the viewer. In some implementations, the viewing distance V can be determined using the proximity sensor 324 (shown in FIG. 3). In some other implementations, an appropriate visual distance can be assumed (such as about 10 cm to about 100 cm).

The CFF model also considers a display luminance Lᵣ of the display module 304 in the OFF state. In some implementations, the display luminance Lᵣ can represent the ambient light levels in relation to the display module 304. In some implementations, Lᵣ may be calculated as follows:

Lᵣ=r_{d}Lₐ (4)

where r_{d} represents a display reflectance and Lₐ represents an adaptation luminance of the display module 304. The display reflectance r_{d} (also know as display reflectivity) is the fraction of incident light power that is reflected from the surface of the display module 304 facing the viewer. The display reflectance r_{d} is typically expressed as a percentage (such as about 10% to about 70%). The adaptation luminance Lₐ (also known as “adaptation brightness”) represents the average luminance of objects and surfaces in the immediate vicinity of the viewer and is a function of the ambient light level. The adaptation luminance Lₐ can range from about 320 lux to about 500 lux for surfaces illuminated by indoor (e.g., office) lighting, from about 1000 lux to about 25000 Klux for surfaces illuminated by full daylight, and from about 32000 lux to about 1000000 lux for surfaces illuminated by direct sunlight.

As discussed above, the output sequence determination (stage 511) can include identifying the time periods of various subframes for each of the subfield colors. In some implementations, the subfield colors can include red, green, and blue. In some implementations, the subfield colors may also include an “x-channel color,” which can include composite colors, such as white, cyan, magenta, yellow, etc. In some implementations, the x-channel color can be a FSCC, which is discussed above in relation to preprocessing the image frame in stage 504 of FIG. 5A. In some implementations, the x-channel color is a fixed FICC. In one example, subframe time periods can be determined as follows:

t_{R}=τ_{R}w_{R}; t_{G}=τ_{G}w_{G}; t_{B}=τ_{B}w_{B}; and t_{X}=τ_{X}w_{X} (5)

where t_{R}, t_{G}, t_{B}, and tₓ, represent the time periods corresponding to subframes of colors red, green, blue, and x, respectively; τ_{R}, τ_{G}, τ_{B}, and τₓ, represent time period of the least significant subframe; and w_{R}, w_{G}, w_{B}, and wₓ, represent the relative weights of the corresponding subframe. As an example, if the weight of a subframe for the color red (R) is 16, and the time period for the least significant subframe (having weight equal to 1) for the color red is 6 μs, then the time period for that subframe would be equal to 16×6 μs=96 μs.

The CFF model also incorporates a DC retinal luminance factor, E_{obs}, for a viewer. To determine the value of E_{obs}, the flicker control logic 406 determines a pupil diameter dₚ corresponding to a given display luminance Lₜ in the ON state from Crawford's formula, as shown below:

dₚ=5−2.2 tan h(0.61151+0.447 log₁₀Lₜ) (6)

In some implementations, the value of the pupil diameter may be kept at a constant value (or a pre-selected range of values) determined, for example, by experimentation. In some implementations, values for dₚ based on various Lₜ levels are stored in a LUT accessible by the flicker control module 406.

The CFF model also considers a pupil area Aₚ corresponding to the pupil diameter dₚ, as follows:

$${A}_{p} = π \frac{{d}_{p}^{2}}{4} \qquad ( 7 )$$

Subsequently, the DC retinal luminance E_{obs} is determined as follows:

E_{obs}=(Lₜ−Lᵣ)Aₚ (8)

where, as discussed above, Lₜ and Lᵣ represent the display luminance in the ON and the OFF states of the display module 304, respectively.

The CFF model also takes into consideration amplitudes of the fundamental components of each subframe of each color. For example, the amplitude A_{R} of a red subframe can be determined as follows:

$${A}_{R} = \frac{4}{C} \frac{C - 1}{C + 1} sin ( \frac{π {t}_{R}}{T} ) \qquad ( 9 )$$

where, C represents the contrast ratio of the display module 304; t_{R}, as determined above in Equation (5), represents the illumination time for that subframe; and T represents the illumination time of the image frame (i.e., reciprocal of the image frame rate). The amplitude A_{G}, A_{B}, and A_{X}, of the subframes associated with the other colors green, blue, and x can be similarly determined.

With the DC retinal luminance E_{obs} and the amplitude A_{R}, A_{G}, A_{B}, and A_{X} known, the flicker control module 406 can determine the DC component of the luminance for each subframe. For example, the DC component of the luminance (E_{obs(R)}) for a red subframe can be determined as follows:

E_{obs(R)}=E_{obs}A_{R}v_{R} (10)

where, v_{R} represents the relative illumination intensity of the red subframe. In some implementations, the relative illumination intensity of the color red can represent the photopic weight of the color red. In some implementations, for example, the photopic weights for the colors red, green, and blue can be about 20%, about 70%, and about 10%, respectively. In a similar manner, the DC component of the luminances E_{obs(G)}, E_{obs(B)}, and E_{obs(x)} can be determined.

Finally, the flicker control module 406 determines the CFF for each subframe of each color. For example, the CFF of a subframe of the color red (R) can be determined as follows:

CFF_{(R)}=m+n ln E_{obs(R)} (11)

where m and n represent regression coefficients determined for the display visual angle θ, determined above in Equation (3). In some implementations, for example, the regression coefficients m and n can be determined for fixed values of the display visual angle θ as described in “Predicting Flicker Thresholds for Video Display Terminals,” J. E. Farrell, Brian L. Benson, and Carl R. Haynie, Proc. SID, vol. 28/4, 1987, pp. 449-453. In some implementations, the regression coefficients m and n for values of θ, other than the fixed values, can be determined using interpolation. In a similar manner, the CFF_{(G)}, CFF_{(B)}, and CFF₍ₓ₎ for subframes associated with colors G, B, and x, can determined.

Table 1 shows example values of CFFs for various subframes determined by the flicker control module 406 using the CFF model discussed above.

TABLE 1

| | Weight | | | | | | | | |
|---|---|---|---|---|---|---|---|---|---|
| Color | 80 | 32 | 16 | 8 | 4 | 1 | 2 | 32 | 80 |
| Red | 53 | 45 | 39 | 34 | 28 | 16 | 22 | 45 | 53 |
| Green | 69 | 62 | 56 | 51 | 45 | 33 | 39 | 62 | 69 |
| Blue | 44 | 36 | 31 | 25 | 19 | 8 | 13 | 36 | 44 |
| x | 71 | 63 | 58 | — | — | — | — | 63 | 71 |

Table 1 shows the values of CFFs determined for 9 subframes each for color subfields Red, Green, and Blue, and for 5 subframes for the x-channel subfield. In this example, the x-channel subfield corresponds to the color white. The 9 subframes for colors Red, Green, and Blue have weights: 80, 32, 16, 8, 4, 1, 2, 32, and 80, while the 5 subframes for the x-channel color have weights 80, 32, 16, 32, and 80. The values shown in Table 1 represent only one example for the values determined using the CFF model based on example values for display dimensions, viewing distance, color gamut, ambient light levels, frame rate, etc.

Referring back to FIG. 5B, the process 550 further includes the flicker control module 406 determining whether CFFs associated with any subframes exceed an illumination frequency of the respective subframes (stage 512). In some implementations, the illumination frequency can be equal to the rate at which the image frames are displayed by the display module 304. For example, if the display module 304 displays the image frames at a rate of 60 image frames per second, then the illumination frequency can be equal to 60 Hz. Subframes with CFFs greater than this illumination frequency have an increased likelihood of resulting in noticeable flicker.

If the flicker control module 406 determines that the CFF of one or more subframes exceeds the illumination frequency of the subframe (for example, the green subframes in Table 1 with weights of 80 and 32 and the x-channel subframe with weights of 32), the flicker control module 406 executes one or more flicker mitigating measures (stage 514). In some implementations, the flicker control module 406 may execute one or more flicker mitigating measures only if the CFFs of a certain percentage of the total number of subframes exceed their respective illumination frequencies. For example, if CFFs of 25% or more of the total number of subframes exceed their respective illumination frequencies, then the flicker control module 406 may execute one or more flicker mitigating measures. In some implementations, instead of a percentage, the flicker control module 406 may determine if the CFFs of a certain number of subframes exceed their respective illumination frequencies. For example, if the CFFs of a threshold number (e.g., 1, 2, 4, etc.) of subframes exceed their respective illumination frequencies, then the flicker control module 406 may execute one or more flicker mitigation measures.

If the flicker control module 406 determines that the conditions for executing the flicker mitigating measures are not met, then the process 550 can continue to determine light source intensities (stage 518) and providing the output sequence (stage 520). While the flicker control logic 406 may execute various flicker mitigating measures, three such flicker mitigating measures are shown in FIG. 5B. Specifically, the flicker control logic 406 may execute one or more of reducing the display module brightness (stage 516a), dividing display of a subframe (stage 516b), reducing the subframe time period (stage 516c), and selecting a different color gamut that would result in a reduction in the CFF (stage 516c). Each of these flicker mitigating measures are discussed below in detail.

In some implementations, the process 550 may include reducing the brightness of the display module 304 (stage 516a). In some implementations, the flicker perceived for a subframe can depend on a difference in the brightness of the display module 304 and the ambient light levels. Specifically, the perception of flicker for a subframe may increase with an increase in the difference between the brightness of the display module and the ambient light levels, and decrease with the decrease in the difference. For example, in some implementations, Lₜ and Lᵣ, in Equation (8), may represent the brightness of the display module and the ambient light levels, respectively. An increase in the difference between Lₜ and Lᵣ can increase the magnitude of the DC retinal luminance E_{obs}, which, in turn (referring to Equation (11)), can increase the CFFs associated with the subframes. An increase in the CFFs, with the illumination frequencies remaining substantially the same, can increase the perception of flicker for some subframes. Conversely, a decrease in the difference between Lₜ and Lᵣ can reduce the CFFs, resulting in a decrease in the perception of flicker.

In some implementations, the flicker perceived for a subframe can depend on a ratio of the brightness of the display module 304 and the ambient light levels. Specifically, the perception of flicker for a subframe may increase with an increase in the magnitude of the ratio of the brightness of the display module over the ambient light levels. In some implementations, the process 550, upon determining that the CFF for one or more subframes is greater than their respective illumination frequencies, may decrease the magnitude of the ratio by decreasing the brightness of the display module 304. A decrease in the ratio could, in turn, decrease the perception of flicker of the one or more subframes.

In some implementations, the process 550 may include dividing the display of a subframe (stage 516b). For example, in some implementations, display of one or more of the subframes of a particular color may be temporally divided into two or more divided-subframes. The divided-subframes can result in an increase in the effective display frequency of the subframe. This increase in the effective display frequency of the subframe increases the illumination frequency for that subframe, which, in turn, decreases the perception of flicker of that subframe.

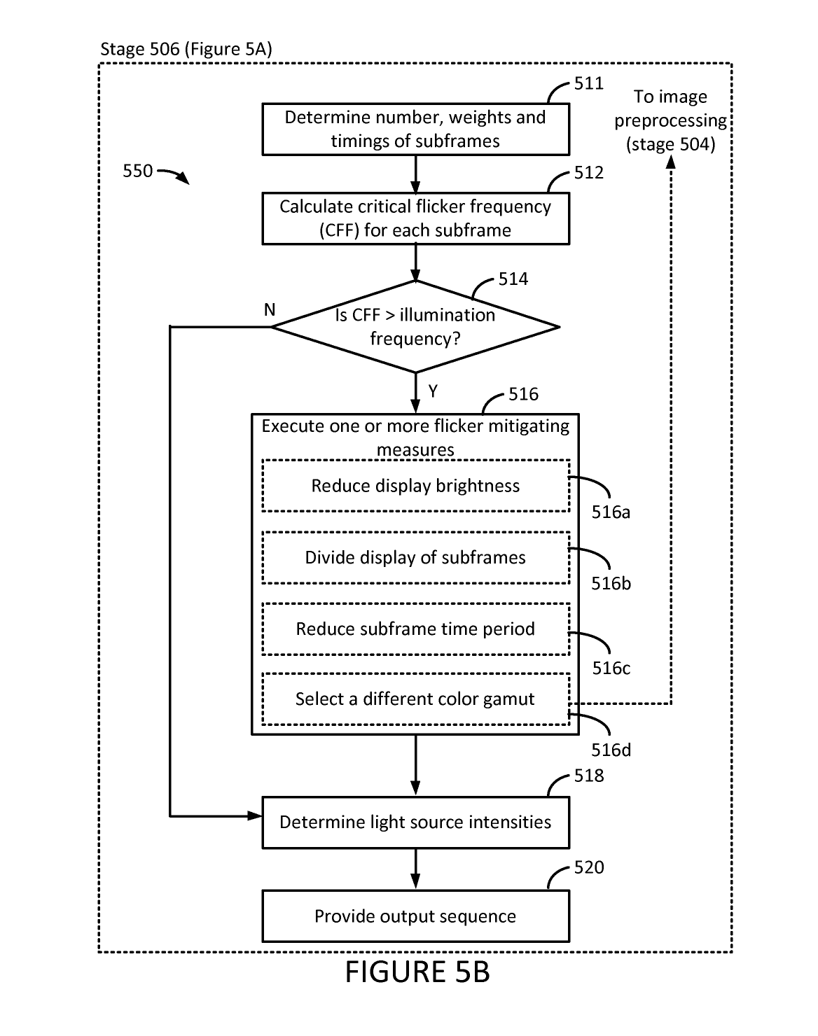

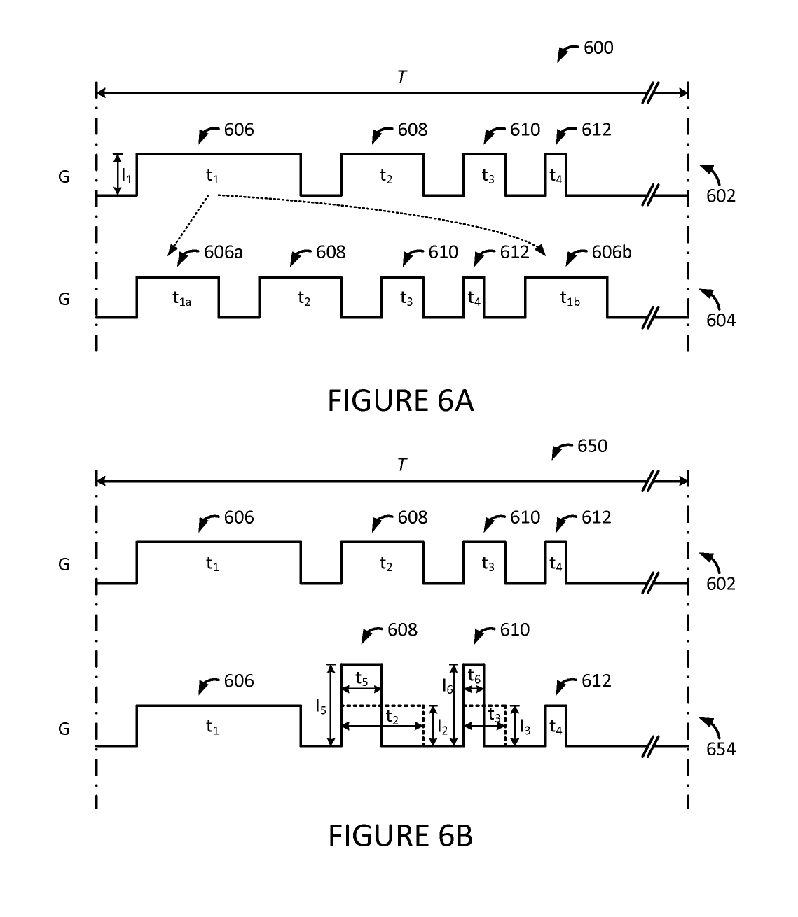

FIG. 6A shows an example timing diagram 600 for dividing a subframe as a flicker mitigating measure. In particular, the timing diagram 600 shows subframes for the color green (G) during a portion of an image frame period T. The timing diagram 600 includes two waveforms 602 and 604. The waveform 602 shows the subframes for the color green in instances where subframe dividing is not implemented. Waveform 604 shows the subframes when subframe dividing is implemented. The waveform 602 includes four weighted subframes: a first subframe 606, a second subframe 608, a third subframe 610 and a fourth subframe 612. The fourth subframe 612 is the least weighted (or least significant) subframe, while the first subframe 606 is the most significant subframe. For example, if the fourth subframe 612 were to have a weight of ‘1’, then the first, second, and third subframes 606, 608, and 610 may have weights of 8, 4, and 2, respectively. Generally, for subframes that are displayed at equal lamp intensities, the weights indicate the relative time durations for which each subframe is displayed. For example, time periods t₁, t₂, and t₃ for which the first, second, and third subframes 606, 608, and 610 are displayed are 8, 4, and 2 times the time period t₄ for which the fourth subframe is displayed. It should be noted that the number of subframes and their relative weights shown in FIG. 6A is merely an example, and that different implementations may employ a different number of subframes and/or different weights.

In FIG. 6A, it is assumed that the first subframe 606 has been determined to have a CFF that is greater than the illumination frequency (in stage 514). The waveform 604 shows one example of displaying divided subframes to mitigate flicker. In particular, instead of displaying subframe 606 as shown in waveform 602, two divided-subframes 606a and 606b, having display time periods equal to t₁ₐ and t_{1b}, respectively, are displayed. In some implementations, the time periods t₁ₐ and t_{1b} can be equal, while in some other implementations, the time periods may be unequal. However, the sum of the time period t₁ₐ and t_{1b} is generally equal to the time period t₁ of the first subframe. Even though the display of subframe 606 is divided into two divided-subframes 606a and 606b, the same data is loaded and displayed during each of the two divided-subframes 606a and 606b. FIG. 6A shows that the second, third, and the fourth subframes 608 610, and 612, are displayed between the two divided-subframes 606a and 606b. However, in some other implementations, the order in which the divided-subframes 606a and 606b are displayed in relation with the other subframes may be different.

Displaying divided-subframes 606a and 606b increases the frequency with which the subframe 606 is displayed. In some cases, this illumination frequency is increased beyond the CFF for the subframe 606, thereby decreasing, and in some cases eliminating, the perception of flicker of the subframe 606. In some implementations, the flicker control logic 416 may execute the divided subframes flicker mitigation measure prior to executing any other flicker mitigation measure.

In some implementations, the measures for mitigating flicker can include displaying a subframe for a reduced time period (stage 516c). In some implementations, the subframe time period can be reduced along with a proportional increase in the intensity of the light. The increase in the intensity of light is performed so that the total light output of the subframe remains unchanged despite the reduction in the subframe time period. In some implementations, this increase in the intensity of light may contribute toward decreasing the perception of flicker for that subframe.

FIG. 6B shows an example timing diagram 650 utilizing the reduction of a subframe time period as a flicker mitigating measure. In particular, the timing diagram 650 shows subframes for the color green (G) during a portion of an image frame period T. The waveform 602 shown in FIG. 6A is used as an example in FIG. 6B to show the application of the subframe time period reduction technique, the result of which is shown in waveform 654. It is assumed that the second and third subframes 608 and 610 have been determined to have CFFs that are greater than the illumination frequency. Thus, the subframe time reduction technique is applied to these two subframes. The waveform 654 depicts displaying the second and third subframes 608 and 610 with time periods t₅ and t₆, respectively. The time periods t₅ and t₆ are less than the corresponding time periods of t₂ and t₃ of the second and third subframe in waveform 602. As the total light output during each of the second and third subframes 608 and 610 is kept substantially unchanged, the light intensity during each of the two subframes is increased accordingly. Generally, the light intensity I₅ for the reduced subframe is selected such that I₅×t₅=I₂×t₂, where I₂ is the light intensity for the second subframe when the subframe time period reduction technique is not applied. Similarly, the light intensity I₆ of the reduced third subframe 610 is selected such that I₆×t₆=I₃×t₃, where I₃ is the light intensity for the third subframe when the subframe time period reduction technique is not applied. Displaying other subframes with reduced time periods can be carried out in a manner similar to that shown for the third and fourth subframes 608 and 610 in FIG. 6B.

Referring again to the process 550 in FIG. 5B, executing one or more flicker mitigating measures (stage 516) by the flicker control logic 406 can also include selecting a different color gamut (stage 516d). In some implementations, flicker can be caused by the color gamut being employed by the display module 704 for displaying image frames. Specifically, subframes of some colors (such as green or the x-channel) may be displayed at a lower intensity when certain color gamuts are employed—resulting in perceived flicker. In some such implementations, selecting a different gamut may result in a change in the relative photopic weights of one or more colors utilized for displaying the image. As shown in Equation (10) above, changes in the relative photopic weights of the colors, (represented by the relative illumination intensity v) may result in the change in the DC component of the luminance (E_{obs}) of the respective colors. Changes in the values of E_{obs} may, in turn, result in a change in the CFF associated with the color. In some implementations, flicker associated with subframes of a particular color can be reduced by selecting a color gamut that results in a decrease in the CFF of the color. The color gamut could be selected from a variety of color gamuts stored in memory.

In some implementations, due to a change in the color gamut for reducing flicker, the control logic 400 may recalculate the FICCs and FSCC subfields that were determined during preprocessing the image frame (stage 504). As a result, after selecting a different color gamut (stage 516d), the process 500 may again preprocess the image frame with the different color gamut to determine new values for the FICCs and the FSCC subfields. In some implementations, the process 550 may also re-determine the number, weights, and timings of the subframes (stage 510), calculate the CFF for each subframe (stage 512), and re-calculate the critical flicker frequency (CFF) associated with each subframe of each color (stage 514). If the change in the gamut results in the CFF of the subframe to fall below the illumination frequency of the subframe, then the process 550 can continue to determine light source intensities (stage 518) and provide the output sequence (stage 520). However, if the CFF of the subframe remains above the illumination frequency, one or more of the other flicker mitigation measures may be employed to reduce flicker.

The process 550 further includes determining light source intensities (stage 518). In some implementations, the light source intensities (or LED intensities) can be a function of the color gamut used to form the image, the color of the FSCC (if any) and any scaling factor determined by the CABC logic 412 discussed above. In some implementations, the light source intensities can also be a function of a reduction in brightness introduced as a flicker mitigating measure at stage 516a.

The process 550 includes providing the output sequence (stage 520). In some implementations, the output sequence is provided to the output logic 410, which can utilize the output sequence to generate the appropriate driver signals to display the subframes. In instances where the flicker mitigation measures are not implemented, the output sequence provided to the output logic 410 can be the initial output sequence determined during stage 511. That is, the output sequence can include, in part, the initially determined numbers, weights, and timings of subframes. In instances where the flicker mitigating measures are executed, the numbers, weights, and timings of the subframes may be modified (as described above in relation to stage 516). In such instances, the output sequence provided to the output logic 410 can include the modified numbers, weights, and timings of the subframes. The output sequence can also include the intensity levels of the light sources during each subframe.

After generating the output sequence, the output logic 410 can present the subframes in a manner discussed above in relation to stage 510.

In some implementations, the flicker control logic 406 may not execute the process stages 512, 514 and 516 shown in FIG. 5B for every image frame. In some such implementations, the flicker control logic 406 may monitor various aspects of the display to determine whether to run the CFF model (stage 512) and to possibly execute one or more flicker mitigating measures (stages 514 and 516). For example, in some implementations, the flicker control logic 406 may base the execution of stages 512, 514, and 516 on changes in user defined brightness levels made by the user under substantially unchanged ambient light conditions. As mentioned above, the microprocessor 316 (shown in FIG. 3), receives ambient light levels from the ambient light sensor 322. Under conditions where the CFFs for the subframes are known to be below the illumination frequency and the ambient light levels received from the ambient light sensor 322 are relatively unchanged, the flicker control logic 406 can monitor changes in the brightness levels of the display module 304. If the brightness levels of the display module 304 remain unchanged, the flicker control module 406 can refrain from executing stages 512, 514, and 516 of the process 550. By refraining from executing the process stages 512, 514, and 516, the control module 400 can save the power that would have been consumed in executing these stages every image frame.

If the flicker control module 406 determines that the user has increased the brightness levels of the display module 304 over a certain brightness threshold level, or by more than a threshold amount, the flicker control module 406 can, for the next received image frame, calculate the CFFs for each subframe and (stage 512) and determine whether the CFFs of any of the subframes are over the threshold (stage 514). Generally, an increase in the brightness of the display module 304, while the ambient light levels remain unchanged, may cause an increase in the CFF of one or more subframes. Thus, if the flicker control module 406 determines that CFFs of one or more subframes are over their respective illumination frequencies, the flicker control module may execute one or more flicker mitigating measures (stage 516). In some implementations, the flicker control module 406 may carry out flicker mitigating measures for only the brightest color subfields, such as the x-color subfield or the green color subfield. In some implementations, if higher brightness is desired by the user, the flicker control module 304 does not utilize reducing the display module brightness (stage 514a) as a flicker mitigating measure. Instead, the flicker control module 406 may choose to either divide the display of the flicker prone subframes or to reduce the time period of the flicker prone subframes (stage 516b) as a flicker mitigating measure.

Dividing the display of a subframe increases the number of times the subframe is loaded into the display elements, resulting in an increase in the power consumed to address and load the subframes into the display elements. The increase in the power consumed for addressing and loading the subframes can, in turn, result in an increase in the overall power consumption of the display device. In some such implementations, if the resulting power consumption increases over a threshold power value, the flicker control module 406 may choose not to divide subframe(s) (stage 516b) as a flicker mitigating measure. Instead, the flicker control module 406 may select a different color gamut that not only reduces flicker but also maintains the overall power consumption of the display device below the threshold power value.

If the flicker control module 406 determines that the user has reduced the brightness level of the display module 304 below a certain brightness threshold level, the flicker control module 406 may refrain from executing stages 512, 514, and 516, and instead, execute power saving measures. For example, in some implementations, the flicker control module 406 may increase the durations of one or more subframes and reduce the illumination intensities of the corresponding light sources to reduce power consumption in a manner such that the total light output during each of the one or more subframes remains substantially unchanged. In some other implementations, the flicker control logic 406 can increase the amount of spatial dithering. In some other implementations, the flicker control logic 406 can drop one or more subframes, and utilize the additional time made available by the dropped subframes to increase the durations of one or more remaining subframes. Increasing durations of the remaining subframes, can provide power savings by allowing reduction in illumination intensities of one or more light sources. In some other implementations, the flicker control module 406 may save power by reducing the image frame rate. In some implementations, while the power saving measures are being executed, the flicker control logic 406 may continue monitoring the CFFs of the subframes to ensure that the power saving measures employed do not inadvertently cause flicker.

In some implementations, the flicker control module 406 may base execution of stages 512, 514, and 516 on the proximity of the user from the display module 304. For example, as shown in FIG. 3, the microprocessor 316 receives user proximity data from the proximity sensor 324. Typically, the perception of flicker of one or more subframes may increase as the user moves closer to the display module 304. For example, referring to Equation (3), the visual angle θ subtended by the display module on the viewers eye would increase as the viewing distance between the viewer and the display module decreases. An increase in the visual angle θ, may, in turn, result in an increase in the regression coefficients m and n—resulting in an increase in the CFF (see Equation (11)). In some implementations, the flicker control logic 406 may monitor the proximity of the user, and if the proximity of the user is reduced below a viewer proximity threshold value, the flicker control logic 406 may execute stages 512 and 514 to determine whether CFFs of any subframes are over the illumination frequency, and execute flicker mitigation measures (stage 516) if needed. On the other hand, if the proximity of the user is at or above the viewer proximity threshold value, the flicker control logic 406 may cease determining CFFs for one or more subframes. In some implementations, the viewer proximity threshold value can be experimentally determined.

In some implementations, the flicker control module 406 may base execution of stages 512, 514, and 516 on the ambient light levels. For example, the flicker control logic module 406, under conditions where the CFFs have been determined to be previously below the illumination frequencies of all subframes, may execute the process stages 512, 514, and 516 if the ambient light levels decrease below a certain ambient light threshold or by more than a threshold amount. For example, the flicker control module 406 can monitor the ambient light levels received from the ambient light sensor 322 (shown in FIG. 3) and compare the received ambient light levels with an ambient light threshold. If the received ambient light levels are below the ambient light threshold, the flicker control logic 406 can execute stages 512 and 514 to determine the CFFs of the subframes and determine whether the CFFs of any subframes are above their respective illumination frequencies. Generally, a reduction in the ambient light levels, while keeping the brightness levels of the display module 304 substantially unchanged, can increase the perception of flicker of one or more colors. Thus, if the CFFs of one or more subframes exceed their respective illumination frequencies, the flicker control logic 406 can execute one or more flicker mitigation measures (stage 516).

In some implementations, the flicker control logic 406 can determine the CFFs of one or more subframes only if the ambient light levels reduce below an ambient light level threshold for a given brightness level of the display module 304. In some implementations, the ambient light level threshold can be experimentally determined. In some implementations, if the ambient light levels exceed the ambient light threshold for a given brightness level of the display module 304, the flicker control logic 406 can cease determining CFFs for one or more subframes. In some implementations, the flicker control logic 406 can execute power saving measures if the ambient light levels exceed the ambient light threshold. Generally, if the ambient light levels are substantially greater than the brightness levels of the display module 304, such as when the display device 100 is located outdoors in daylight, the perception of flicker is reduced. Thus, the flicker control logic 406 can cease determining the CFFs and execute power saving measures such as increasing the durations of one or more subframes, dropping one or more subframes, reducing the image frame rate, refraining from dividing a subframe, etc. In some implementations, the flicker control logic 406 may periodically determine whether the CFFs of any of the subframes, due to the execution of one or more power saving measures, have increased over the threshold. If the CFFs of any subframes are over their respective illumination frequencies, the flicker control logic 406 may execute flicker mitigating measures (stage 514) and/or limit the extent to which the power saving measures are executed.

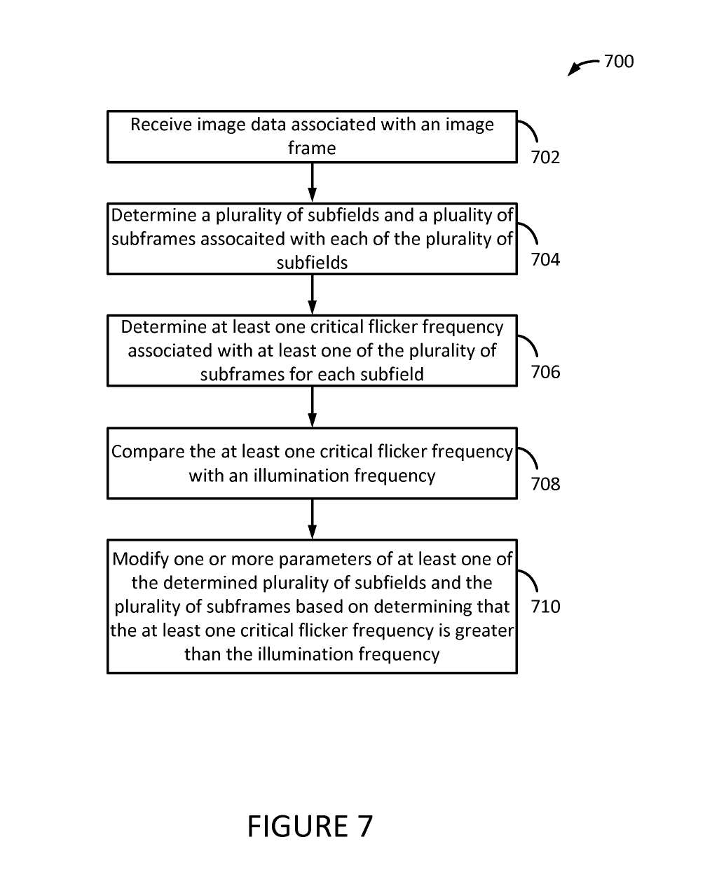

FIG. 7 shows an example flow diagram of another process 700 for displaying an image frame. In particular, the process 700 includes receiving image data associated with an image frame (stage 702), determining a plurality of subfields and a plurality of subframes associated with each of the plurality of subfields (stage 704), determining at least one critical flicker frequency associated with at least one of the plurality of subframes for each subfield (stage 706), comparing the at least one critical flicker frequency with an illumination frequency (stage 708), and modifying one or more parameters of at least one of the determined plurality of subfields and the plurality of subframes based on determining that the at least one critical flicker frequency is greater than the illumination frequency (stage 710).

The process 700 includes receiving image data associated with an image frame (stage 702). On example of this process stage has been discussed above in relation to FIGS. 4 and 5. Specifically, the input logic 402 receives image data as a stream of intensity values for the red, green, and blue components of each pixel in an image frame.

The process 700 further includes determining a plurality of subfields and a plurality of subframes associated with each of the plurality of subfields (stage 704). One example of this process stage has been discussed above in relation to FIGS. 4 and 5A. Specifically, the control logic 400 can pre-process the received image data (stage 504 in FIG. 5A). In some implementations, the pre-processing can include determining a plurality of FICCs and an FSCC to be utilized for displaying the image data.

The process 700 further includes determining at least one critical flicker frequency associated with at least one of the plurality of subframes for each subfield (stage 706). On example of this process stage has been discussed above in relation to FIGS. 4-5B. For example, the flicker control logic 406 determines critical flicker frequencies at stage 512 shown in FIG. 5B.

The process 700 also includes comparing the at least one critical flicker frequency with an illumination frequency (stage 708). One example of this process stage has been discussed above in relation to FIGS. 4-5B. For example, the flicker control logic 406 compares the CFFs determined for the plurality of subframes to their respective illumination frequencies (stage 514). In some implementations, the illumination frequencies can be equal to the image frame rate utilized for displaying the image frames.

The process 700 further includes modifying one or more parameters of at least one of the determined plurality of subfields and the plurality of subframes based on determining that the at least one critical flicker frequency is greater than an illumination frequency (stage 710). Examples of this process stage have been discussed above in relation to FIGS. 4-6B. For example, the flicker control logic 406, upon determining that the CFF associated with a subframe exceeds the illumination frequency of that subframe, executes one or more flicker mitigating measures. In some implementations, the flicker mitigating measures can include, for example, dividing the display of a subframe (as shown in FIG. 6A) and reducing the duration of a subframe (as shown in FIG. 6B), reducing the display brightness, and selecting a different color gamut.

In some implementations, the control logic 400 may carry out subframe dividing (as shown in the example in FIG. 6A) based on factors besides the likelihood of flicker perception. Subframe dividing (that is, displaying of a subframe during two or more illumination periods) has benefits in mitigating other image artifacts beyond just flicker. For example, subframe dividing can help reduce color break-up (CBU). However, as indicated above, employing subframe dividing results in increased power consumption due to the need to load the data associated with the divided subframes additional times into the array of display elements and actuate the display elements based on that data multiple times in a given image frame. In addition, because the addressing and actuation process takes time, the amount of time available for illuminating light sources for a given image frame is decreased. Accordingly, the intensity of the light sources may need to be increased to maintain a similar brightness level. As many light sources have non-linear power curves, operating a light source at a higher intensity tends to be less power efficient than operating the light source at a lower intensity, further potentially increasing the power consumption resulting from the use of subframe dividing. As such, dividing subframes is desirable when beneficial in reducing image artifacts, but it may be advantageous to avoid subframe dividing when its benefits are reduced.

In general, the image artifacts mitigated by dividing a subframe, such as flicker and CBU, are less prevalent under higher ambient light conditions. As such, the control logic 400, in some implementations, can be configured to determine whether to display image frames using subframe dividing based ambient levels without consideration of critical flicker frequencies of any given subframe. That is, the control logic 400 can determine to use subframe dividing in response to determining that ambient light levels, for example, received from the ambient light meter 322 (shown in FIG. 3), have fallen below an ambient light threshold. On the other hand, the control logic 400 can refrain from using subframe dividing in response to determining that the ambient light levels are above the ambient light threshold. In some implementations, the control logic 400 can determine a difference (or a ratio) between the ambient light levels and the display brightness to determine whether to use subframe dividing. For example, the control logic 400 may use subframe dividing if the result of the subtraction of the ambient light level from the display brightness level is above a difference threshold value. In some implementations, the control logic 400 may use subframe dividing if the ratio of the display brightness level over the ambient light levels is above a ratio threshold value (for example, above a value of about 1:20).

In addition, the benefits of dividing a subframe are to some extent color dependent. That is, the benefits increase in proportion to the relative perceived brightness of the color to the human visual system. For example, the dividing of a white, green, or yellow subframe will have a greater artifact mitigating impact than dividing a red or blue subframe. This benefit is particularly strong for colors that may not be displayed as frequently during an image frame period. For example, as indicated in Table 1 above, in some implementations, the display output sequence includes the display of fewer, higher weighted subframes for the x-channel than for the remaining color channels, such as red, green, or blue. Moreover, the x-channel is typically selected (either as a FICC or FSCC) to be a composite color. A composite color refers to a color formed from a combination of at least two primary colors of the color gamut being used by the display. In contrast, the other color subfields tend to be component color subfields. A component color is a color which is formed primarily from a single primary color of the color gamut being displayed. In addition, the x-channel subfield tends to carry a substantially large portion of the luminance of a given image frame and is often of a color perceived by the human visual system to be relatively brighter than other colors. As such, the decision to divide an x-channel subframe has increased impact on the perception of image artifacts relative to the decision to divide other subframes.

Accordingly, the control logic 400 can be configured to sense ambient light conditions and determine whether to divide the subframes associated with the x-channel subfield based on the ambient light levels. In some such implementations, if the ambient light levels are high (or are high relative to the display brightness), the control logic 400 opts to display each subframe associated with the x-channel as a single, temporally contiguous subframe. On the other hand, if the ambient light levels are low (or are low relative to the display brightness), the control logic 400 opts to divide at least one subframe associated with the x-channel subfield, displaying that subframe, for example, twice during the image frame time period. In some implementations, the control logic 400 can display the subframe associated with the x-channel subfield more than two times. For example, the control logic 400 can display the subframe three or more times during the image frame period.

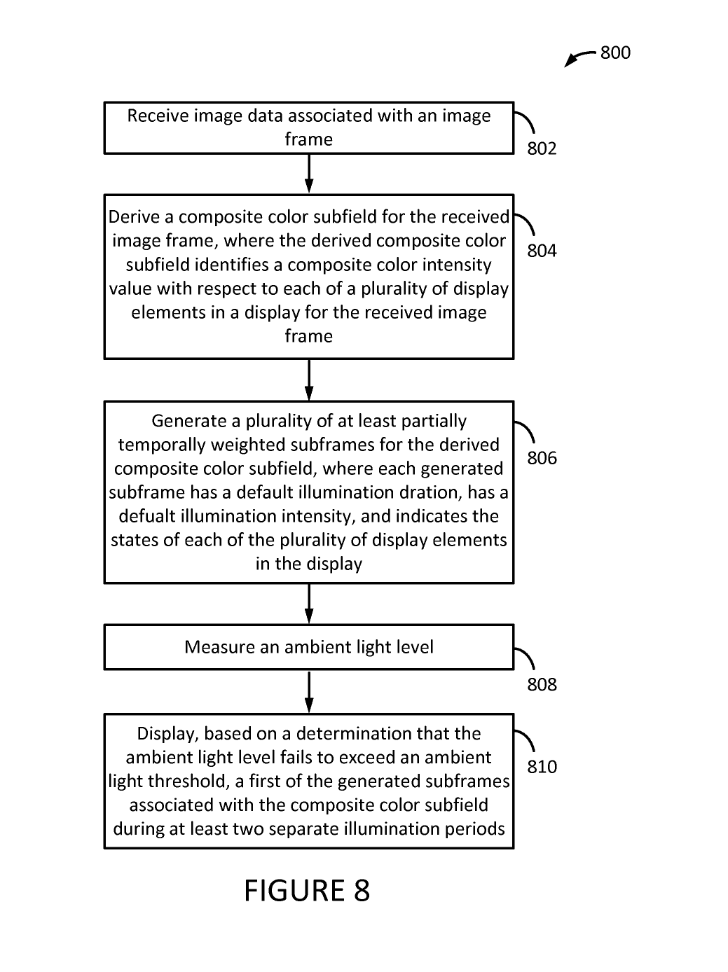

FIG. 8 shows a flow diagram of an example process 800 for dividing subframes based on ambient light conditions. In particular, the process 800 includes receiving image data associated with an image frame (stage 802), deriving a composite color subfield for the received image frame, where the derived composite color subfield identifies a composite color intensity value with respect to each of a plurality of display elements in a display for the received image frame (stage 804), generating a plurality of at least partially temporally weighted subframes for the derived composite color subfield, where each generated subframe has a default illumination duration, has a default illumination intensity, and indicates the states of each of the plurality of display elements in the display (stage 806), measuring an ambient light level (stage 808), and displaying, based on a determination that the ambient light level fails to exceed an ambient light threshold, a first of the generated subframes associated with the composite color subfield during at least two separate illumination periods (stage 810).

The process 800 includes receiving image data associated with an image frame (stage 802). Examples of this process stage have been discussed above in relation to FIGS. 3-5A, in which the input logic 402 receives image frame data.

The process 800 further includes deriving a composite color subfield for the received image frame, where the derived composite color subfield includes an intensity value with respect to each of a plurality of display elements in a display for the received image frame (stage 804). One example of this process stage has been discussed above in relation to stage 504 shown in FIG. 5A. In some implementations, the color of the composite color subfield can be a FSCC, selected by the control logic 400 based on the content of the current image frame or one or more previous image frames. In some implementations, the color composite color subfield can be a FICC, such as white, yellow, or cyan. In some implementations, the subfield derivation logic 402 can derive the composite color subfield through a direct mapping of pre-processed image data (for example, red, green, and blue pixel intensity values after transformation using one or more de-gamma curves and after dithering) to a set of red, green, blue and composite color intensity values. In some implementations, the subfield derivation logic analyzes the pre-processed image data to identify intensity values for pixels in the composite color subfield and then reduces the intensity values for the pixels in two or more of the remaining color subfields based on the determined composite color pixel intensity values.

The process 800 also includes generating a plurality of at least partially temporally weighted subframes for the derived composite color subfield, where each generated subframe has a default illumination duration, has a default illumination intensity, and indicates the states of each of the plurality of display elements in the display (stage 806). One example of this process stage has been discussed above in relation to stage 508 shown in FIG. 5A. For example, the subframe generation logic 408 can generate a set of bitplanes based on binary code words stored in LUTs for each intensity value in each color subfield. In some implementations, the subframe generation logic generates fewer subframes than it generates for component color subfields. In some implementations, the intensity and duration of a subframe when subframe division is not carried out can be the default intensity and the default illumination duration of the subframe. For, example, referring to FIG. 6A, the waveform 600 shows subframes for the color green when no subframe division is implemented. The first subframe 606, for example, has default illumination duration t₁ and a default intensity I₁.

The process 800 further includes measuring an ambient light level (stage 808), and displaying, based on a determination that the ambient light level fails to exceed an ambient light threshold, a first of the generated subframes associated with the composite color subfield during at least two separate illumination periods (stage 810). As discussed in relation to FIG. 3, the display module 304 can include an ambient light sensor 322, which measures ambient light levels. The control logic 400 compares the ambient light levels with an ambient light threshold or compares the result of the subtraction of the ambient light level from the display brightness level to a difference threshold value, or compares the result of the ratio of the display brightness level over the ambient light level. If the ambient light levels are less than the ambient light threshold, or if the result of the subtraction is above a difference threshold, or if the result of the ratio is greater than the ratio threshold value, the control logic 400 displays at least one of the composite color subframes during at least two separate illumination periods. For example, displaying a subframe during at least two separate illumination periods can be similar to the subframe division example shown in FIG. 6A. In particular, FIG. 6A shows the division of subframe 606. That is, the subframe 606 is displayed during two illumination periods t₁ₐ (subframe 606a) and t_{1b} (subframe 606b). The data loaded during each of the two illumination periods t₁ₐ and t_{1b} is the same as that loaded if the subframe 606 were to be displayed.

In some implementations, the combined durations of the two separate illumination periods can be substantially equal to the default illumination duration. For example, referring again to FIG. 6A, the combined durations the illumination periods t₁ₐ and t_{1b} can be substantially equal to the default illumination duration of t₁. In some implementations, the illumination intensity of one or both of the two illumination periods during which the subframe is displayed can be increased. In some implementations, the increase in the illumination intensity can be a function of a decrease in the sum of the illumination durations of the separate illumination periods from the default illumination duration. For example, referring to FIG. 6A, the illumination intensity during the illumination periods t₁ₐ and t_{1b} can be increased from the default illumination intensity I₁ as a function of the decrease in the illumination duration from the default illumination duration of t₁ to the sum of illumination periods t₁ₐ and t_{1b}.

If, on the other hand, the ambient light levels are above the ambient light threshold, or if the result of the subtraction is below the difference threshold or if the result of the ratio is less than the ratio threshold value, the control logic 400 refrains from displaying the composite color subframes during the at least two or more illumination periods, and causes each of the composite color subframes to be displayed as single, temporally contiguous subframes. For example, referring again to FIG. 6A, if the control logic 400 determines that subframe division is not needed, then the control logic 400 can display the first subframe 606 as a temporally contiguous subframe as shown in the waveform 602.

FIGS. 9A and 9B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 9B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
input logic configured to receive image data associated with an image frame;
subfield generation logic configured to derive a composite color subfield based on the received image frame, wherein the derived composite color subfield identifies a composite color intensity value with respect to each of a plurality of display elements in a display for the received image frame;
subframe generation logic configured to generate a plurality of at least partially temporally weighted subframes for the derived composite color subfield, wherein each generated subframe has a default illumination duration, has a default illumination intensity, and indicates states of the respective display elements in the display;
an ambient light sensor configured to measure an ambient light level; and
control logic configured to, based on a determination that the ambient light level fails to exceed an ambient light threshold, display a first of the generated subframes associated with the composite color subfield during at least two separate illumination periods.

2. The apparatus of claim 1, wherein a combined duration of the at least two illumination periods is substantially equal to the default illumination duration associated with the first of the generated subframes.

3. The apparatus of claim 1, wherein the control logic is further configured to increase illumination intensities of one or more light sources being illuminated during display of the first of the generated subframes during the at least two separate illumination periods to be greater than the default illumination intensity.

4. The apparatus of claim 3, wherein the control logic is further configured to increase the illumination intensities for the first of the generated subframes as a function of a decrease in the illumination duration for the first of the generated subframe from its default illumination duration.

5. The apparatus of claim 1, wherein the subfield generation logic is further configured to generate color subfields for a plurality of component colors.

6. The apparatus of claim 1, wherein the control logic is configured to, upon determining that the ambient light levels exceed the ambient light threshold, display each of the generated subframes associated with the composite color as individual, temporally contiguous subframes.

7. The apparatus of claim 1, wherein the determination that the ambient level fails to exceed the ambient light threshold includes a determination that an ambient light-to-display brightness ratio fails to exceed an ambient light-to-display brightness ratio threshold.

8. The apparatus of claim 1, wherein the plurality of display elements include MEMS shutter-based light modulators.

9. The apparatus of claim 1, further comprising:
a display;
a processor that is capable of communicating with the display, the processor being capable of processing image data; and
a memory device that is capable of communicating with the processor.

10. The apparatus of claim 9, the display further including:
a driver circuit capable of sending at least one signal to the display; and
a controller capable of sending at least a portion of the image data to the driver circuit.

11. The apparatus of claim 9, the display further including:
an image source module capable of sending the image data to the processor, wherein the image source module comprises at least one of a receiver, transceiver, and transmitter.

12. A method of forming an image on a display, comprising:
receiving image data associated with an image frame;
deriving a composite color subfield for the received image frame, wherein the derived composite color subfield identifies a composite color intensity value with respect to each of a plurality of display elements in a display for the received image frame;
generating a plurality of at least partially temporally weighted subframes for the derived composite color subfield, wherein each generated subframe has a default illumination duration, has a default illumination intensity, and indicates states of the respective display elements in the display;
measuring an ambient light level; and
displaying, based on a determination that the ambient light level fails to exceed an ambient light threshold, a first of the generated subframes associated with the composite color subfield during at least two separate illumination periods.

13. The method of claim 12, wherein displaying a first of the generated subframes during at least two separate illumination periods includes displaying the first of the generated subframe such that a combined duration of the at least two illumination periods is substantially equal to the default illumination duration associated with the first of the generated subframes.

14. The method of claim 12, further including increasing illumination intensities of one or more light sources being illuminated during display of the first of the generated subframes during the at least two separate illumination periods to be greater than the default illumination intensity.

15. The method of claim 14, wherein increasing illumination intensities of one or more light sources being illuminated during display of the first of the generated subframes as a function of a decrease in the illumination duration of the first of the generated subframes from its default illumination duration.

16. The method of claim 12, further comprising generating color subfields for a plurality of component colors.

17. The method of claim 12, further comprising, upon determining that the ambient light levels exceed the ambient light threshold, displaying each of the generated subframes associated with the composite color subfield as individual, temporally contiguous subframes.

18. The method of claim 12, wherein the determination that the ambient level fails to exceed the ambient light threshold includes a determination that an ambient light-to-display brightness ratio fails to exceed an ambient light-to-display brightness ratio threshold.

19. A non-transitory computer readable storage medium having instructions encoded thereon, which when executed by a processor cause the processor to perform a method for displaying an image, comprising:
receiving image data associated with an image frame;
deriving a composite color subfield for the received image frame, wherein the derived composite color subfield identifies a composite color intensity value with respect to each of a plurality of display elements in a display for the received image frame;
generating a plurality of at least partially temporally weighted subframes for the derived composite color subfield, wherein each generated subframe has a default illumination duration, has a default illumination intensity, and indicates states of the respective display elements in the display;
measuring an ambient light level; and
displaying, based on a determination that the ambient light level fails to exceed an ambient light threshold, a first of the generated subframes associated with the composite color subfield during at least two separate illumination periods.

20. The non-transitory computer readable storage medium of claim 19, wherein displaying a first of the generated subframes during at least two separate illumination periods includes displaying the first of the generated subframe such that a combined duration of the at least two illumination periods is substantially equal to the default illumination duration associated with the first of the generated subframes.
